(19) United States
(12) Patent Application Publication
(10) Pub. No.: US 2015/0312938 A1
(43) Pub. Date: Oct. 29, 2015

(54) MTC RACH PROCEDURE

(71) Applicant: TELEFONAKTIEBOLAGET L M ERICSSON (PUBL), Stockholm (SE)

(72) Inventors: Anna Larmo, ESPOO (FI); Riikka Susitaival, HELSINKI (FI)

(21) Appl. No.: 14/648,281

(22) PCT Filed: Nov. 26, 2013
(86) PCT No.: PCT/SE2013/051391

§ 371 Date: May 29, 2015

Related U.S. Application Data
(60) Provisional application No. 61/731,046, filed on Nov. 29, 2012.

(51) Int. Cl. H04W 74/00; H04W 72/04; H04W 4/00

(52) U.S. Cl. CPC H04W 74/006; H04W 4/005; H04W 72/0406; H04W 74/08

(57) ABSTRACT

The present disclosure relates to a method performed by a radio network node. The method comprises receiving respective Preamble transmissions from at least two radio devices. The method also comprises sending a RAR transmission to the at least two radio devices. The method also comprises receiving respective Granted in RAR transmissions from the at least two radio devices. The method also comprises sending a Contention Resolution transmission on a PDCCH to the at least two radio devices, using a shared identifier such that the same, shared, identifier is used for identifying all of said at least two radio devices. The present disclosure also relates to a radio network node, a radio device and a method performed by a radio device.

### TECHNICAL FIELD

The disclosure relates to radio communication, specifically to methods and devices for a contention based Third Generation Partnership Project (3GPP) Long Term Evolution (LTE) random access channel (RACH) procedure on a Physical Downlink Control Channel (PDCCH).

### BACKGROUND

Machine to machine (M2M) communications is foreseen as one of the major traffic generators in the future. Besides the amount of traffic, M2M is likely to bring a high number of new devices connected to the current radio networks.

For example, large deployments of smart meters (e.g. sensors) are likely in the near future, which meters are able to connect to a cellular network. Metering reports might be sent either periodically, or event based. It is likely that event based metering will be used to reduce the traffic to the network generated from the meters. However, event based reporting might easily cause overload situations in the cellular network the meters are connected to, if the event triggering the reporting is the same for a large number of meters in the same area.

In communication in accordance with the Third Generation Partnership Project (3GPP) Long Term Evolution (LTE) radio communication standards, an overload situation might happen in several different ways and situations. For example, it could be that the random access channel (RACH) becomes overloaded so that no User Equipment (UE) gets access to the evolved Node B (eNB) it is trying to reach. Another overload situation might happen for the scheduled radio resources, where the requests are coming in faster than they can be served, leading eventually to a situation where the requests are served too late, i.e., when the User Equipment (UE) or an application in question is not waiting for a response anymore. Overload on scheduled radio resources is typically caused by scarce physical downlink control channel (PDCCH) resources when compared with the number of active users, which dictate how many UEs can be served in a subframe.

The less that is known about a UE's link characteristics, the more resources are required on the PDCCH in order to successfully deliver the control information. PDCCH transmissions can be performed with variable amount of control channel elements (CCEs), where the number varies from one to eight in current 3GPP specifications. The number of CCEs used depends on the UE's link quality. In case the link quality is not know, a robust allocation with a high number of CCEs is typically chosen to be sure that also a UE with a bad link is able to receive the information.

The contention based LTE Random Access Channel (RACH) procedure, by means of which the UE obtains access to the network, comprises four sequential messages (msg). The procedure is illustrated in FIG. 1:

1 Preamble transmission (msg1, uplink (UL))

2 Random Access Response (RAR) transmission (msg2, downlink (DL))

3 Msg3 granted in RAR (msg3, UL)

4 Contention resolution (msg4, DL)

Msg4 is the last crucial message of the contention based RACH procedure. The UE only waits for this message as long as the contention resolution timer is running. If the UE fails to receive msg4 during this period, it will basically start the RACH procedure all over again, thus worsening the possibly already incipient overload. Also worth to note is that the network likely does not have any link information from the UE before msg4 has been received. This is because msg4 typically will carry the RRC Connection Setup message (RRC stands for Radio Resource Control) which will configure the UE for Channel Quality Information (CQI) transmissions which are used by the UE to report the link quality. Thus, the msg4 transmission will in most cases require an eight CCE allocation in the PDCCH.

When a large number of devices are accessing the system within a short time period, such as the scenario described in the Radio Access Network (RAN) overload study of the 3GPP Technical Report (TR) 37.868 “RAN Improvements for Machine-type Communications”, and a rather large number of preambles can be still granted with msg3 transmission resources, a queue is likely to start building up in the DL scheduler, since there are not enough resources, either on PDCCH or on other channels, to schedule all UEs. In the long run, this may lead to UEs not receiving their msg4 within the time period of the contention resolution timer due to the queuing for the resources, and the UEs will thus consider the random access attempt as failed. Typically, the UE will after such a failure re-attempt access on the RACH, thus further increasing the overload.

There is thus a problem in the art with overloading of a control channel in case many users, e.g. M2M, try to connect to the network at the same time.

### SUMMARY

The present disclosure addresses a problem of sending content to several users, in the form of radio devices, simultaneously when no or very little information of the radio link quality is available and control channel resources are limited.

It has now been realised that several of the envisioned machine type communication (MTC) devices in future radio networks might be using cellular networks for communication. This means that the number of users (i.e. radio devices) and especially MTC devices is likely to increase rapidly. Furthermore, situations have been identified where a high number of MTC devices will access the system within a very short time period, e.g. due to event triggered reporting, thus risking the network stability.

The traffic generated by MTC devices is likely to be small and infrequent. For small data transmissions, the control information forms a major part of total consumed resources. Furthermore, when there are devices that transmit only seldom, it is common that the network has no or very little knowledge of their link quality beforehand. When link quality is not known, the network is likely to use a robust resource allocation in order to make sure that the device actually receives the information. This together with a high number of connecting devices implies that the network resources, especially for control channels, become limiting.

The present disclosure addresses the problems described above by grouping the transmissions from MTC radio devices accessing the network at the same time, and thus saving network resources for the normal, i.e. non-MTC, radio devices. In practice this may be done by assigning a common identifier, e.g. a common Radio Network Temporary Identifier (RNTI), for the MTC devices accessing at the same time and then allocating resources of the control channel for the devices simultaneously through the common RNTI. In addition to the situation discussed herein, the use of the common RNTI for the contention resolution message 4 may be extended to all situations where control channel resources can be saved with this mechanism.

According to an aspect of the present disclosure, there is provided a method of a radio network node. The method comprises receiving respective preamble transmissions from at least two radio devices. The method also comprises sending a RAR transmission to the at least two radio devices. The method also comprises receiving respective granted in RAR transmissions from the at least two radio devices. The method further comprises sending a contention resolution transmission on a physical downlink control channel (PDCCH) to the at least two radio devices, using a shared identifier such that the same, shared, identifier is used for identifying all of said at least two radio devices.

According to another aspect of the present disclosure, there is provided a computer program product comprising computer-executable components for causing a network node to perform an embodiment of the method of a radio network node when the computer-executable components are run on a processor comprised in the network node.

According to another aspect of the present disclosure, there is provided a radio network node. The node comprises a processor, and a storage unit storing instructions that, when executed by the processor, cause the node to receive respective preamble transmissions from at least two radio devices. The instructions also cause the node to send a RAR transmission to the at least two radio devices. The instructions also cause the node to receive respective granted in RAR transmissions from the at least two radio devices. The instructions also cause the node to send a contention resolution transmission on a physical downlink control channel (PDCCH) to the at least two radio devices, using a shared identifier such that the same, shared, identifier is used for identifying all of said at least two radio devices.

According to another aspect of the present disclosure, there is provided a computer program comprising computer program code which is able to, when run on a processor of a network node, cause the network node to receive respective preamble transmissions from at least two radio devices. The code is also able to cause the network node to send a RAR transmission to the at least two radio devices. The code is also able to cause the network node to receive respective granted in RAR transmissions from the at least two radio devices. The code is also able to cause the network node to send a contention resolution transmission on a PDCCH to the at least two radio devices, using a shared identifier such that the same, shared, identifier is used for identifying all of said at least two radio devices.

According to another aspect of the present disclosure, there is provided a method of a radio device. The method comprises sending a preamble transmission to a network node. The method also comprises receiving a RAR transmission from said network node, said RAR transmission comprising information about a shared identifier which will be used for a contention resolution transmission. The method further comprises sending a granted in RAR transmissions to the network node. The method also comprises receiving the contention resolution transmission on a physical downlink control channel (PDCCH), which identifies the radio device by a shared identifier which is also identifying at least one other radio device concurrently connecting to the network node.

According to another aspect of the present disclosure, there is provided a computer program product comprising computer-executable components for causing a radio device to perform an embodiment of the method of a radio device of the present disclosure when the computer-executable components are run on a processor comprised in the radio device.

According to another aspect of the present disclosure, there is provided a radio device. The radio device comprises a processor, and a storage unit storing instructions that, when executed by the processor, cause the device to send a preamble transmission to a network node. The instructions also cause the device to receive a RAR transmission from said network node, said RAR transmission comprising information about a shared identifier which will be used for a contention resolution transmission. The instructions also cause the device to send a granted in RAR transmissions to the network node. The instructions also cause the device to receive the contention resolution transmission on a physical downlink control channel (PDCCH), which identifies the radio device by a shared identifier which is also identifying at least one other radio device concurrently connecting to the network node. The radio device may also comprise a receiver and a transmitter, associated with an antenna, which cooperate with the processor to perform the stored instructions.

According to another aspect of the present disclosure, there is provided a computer program comprising computer program code which is able to, when run on a processor of a radio device, cause the radio device to send a preamble transmission to a network node. The code is also able to cause the radio device to receive a RAR transmission from said network node, said RAR transmission comprising information about a shared identifier which will be used for a contention resolution transmission. The code is also able to cause the radio device to send a granted in RAR transmissions to the network node. The code is also able to cause the radio device to receive the contention resolution transmission on a physical downlink control channel (PDCCH), which identifies the radio device by a shared identifier which is also identifying at least one other radio device concurrently connecting to the network node.

According to another aspect of the present disclosure, there is provided a computer program product comprising an embodiment of a computer program according to present disclosure and a computer readable means on which the computer program is stored.

In some embodiments, the shared identifier is a shared RNTI.

In some embodiments, the shared identifier is a shared Random Access RNTI (RA-RNTI).

In some embodiments, the shared identifier is a shared Cell RNTI (C-RNTI).

In some embodiments, the RAR transmission comprises information to the at least two radio devices about which identifier will be used for the contention resolution transmission. In some embodiments, this information also comprises information about that the identifier will be an identifier shared between a plurality of radio devices.

In some embodiments, the information additionally or alternatively comprises information about private identifiers for each of the at least two radio devices.

The present disclosure thus outlines a new type of “machine channel” which can conveniently be used for MTC radio devices—however not restricted to M2M only—in where the network may control the MTC devices accessing the system, and group them under one or several shared RNTIs.

An advantage is that the network is allowed to save PDCCH resources when several radio devices are trying to connect to the network at the same time and several subsequent robust PDCCH allocations are needed for all devices in order to be able to allow them to connect.

Furthermore, embodiments of the present disclosure outline a “machine channel” which may be used to extract MTC traffic under one or several shared RNTIs.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a signalling diagram illustrating the contention based LTE RACH procedure according to prior art.

FIG. 2 is a schematic signalling diagram illustrating an embodiment of a contention based LTE RACH procedure according to the present disclosure.

FIG. 3 is a schematic block diagram of an embodiment of a radio device of the present disclosure.

FIG. 4 is a schematic block diagram of an embodiment of a network node of the present disclosure.

FIG. 5 is a schematic illustration of an embodiment of a computer program product of the present disclosure.

FIG. 6 is a schematic flow chart of an embodiment of a method of a network node, of the present disclosure.

FIG. 7 is a schematic flow chart of an embodiment of a method of a radio device, of the present disclosure.

FIG. 8 is a schematic signalling diagram illustrating a contention based LTE RACH procedure according to the present disclosure.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

The term “overload situation” relating to the cellular network is here used in a wide sense. A more appropriate term could in some cases be “congestion”. However, since it may be difficult to distinguish between when congestion ends and overload starts, the term overload is used throughout the present disclosure.

Radio devices may typically be considered as connecting concurrently to the network if each radio device sends a preamble transmission wherein each sent preamble transmission is received in the same subframe at the network node.

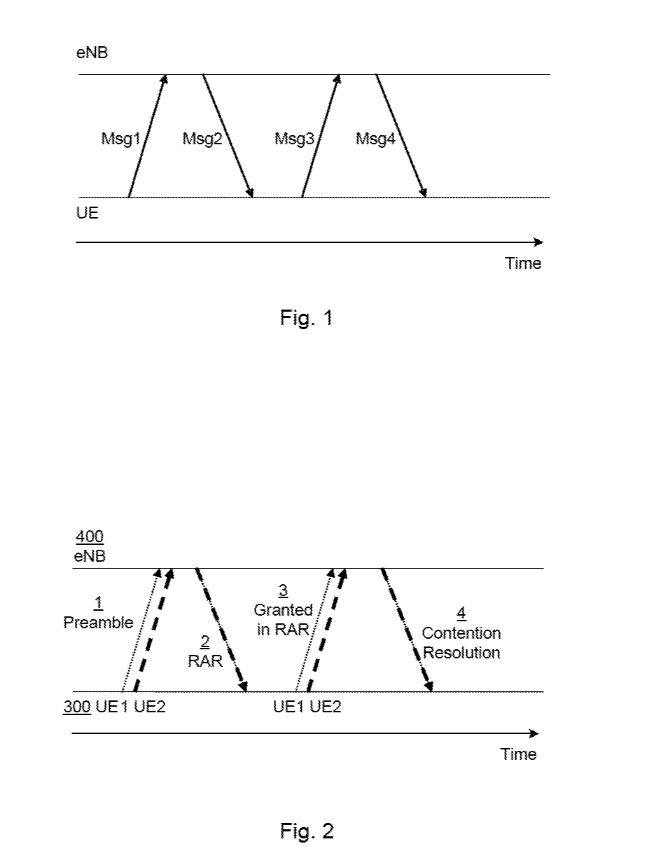

FIG. 2 is a schematic signalling diagram illustrating an embodiment of signalling of a method of the present disclosure and is an alternative to the signalling of the prior art illustrated in FIG. 1. In the updated contention based RACH procedure of FIG. 2, a Preamble transmission 1 is sent from each of the two radio devices 300, here called UE1 and UE2, to a network node 400, here an evolved Node B (eNB). These two preamble transmissions are sent at least partly at the same time (but are depicted slightly displaced in relation to each other in FIG. 2 for clarity), but independently of each other, possibly due to an event that has triggered the RACH procedure of both UE1 and UE2. In response to the two received preamble transmissions 1, the eNB 400 sends a combined RAR transmission 2 to the two devices 300, UE1 and UE2, thereby using less resources of the control channel than if separate RAR transmissions are sent to each radio device 300. Similarly, UE1 and UE2 each sends a Granted in RAR transmission 3 to the eNB 400 in response to the combined RAR transmission 2, and the eNB responds with a combined Contention Resolution transmission 4 using a shared identifier such as a shared RNTI, a shared RA-RNTI or a shared C-RNTI. Thus, less resources of the control channel are used also for the transmission of the contention resolution transmission 4, compared with if separate contention resolution transmissions are sent to each of UE1 and UE2 300.

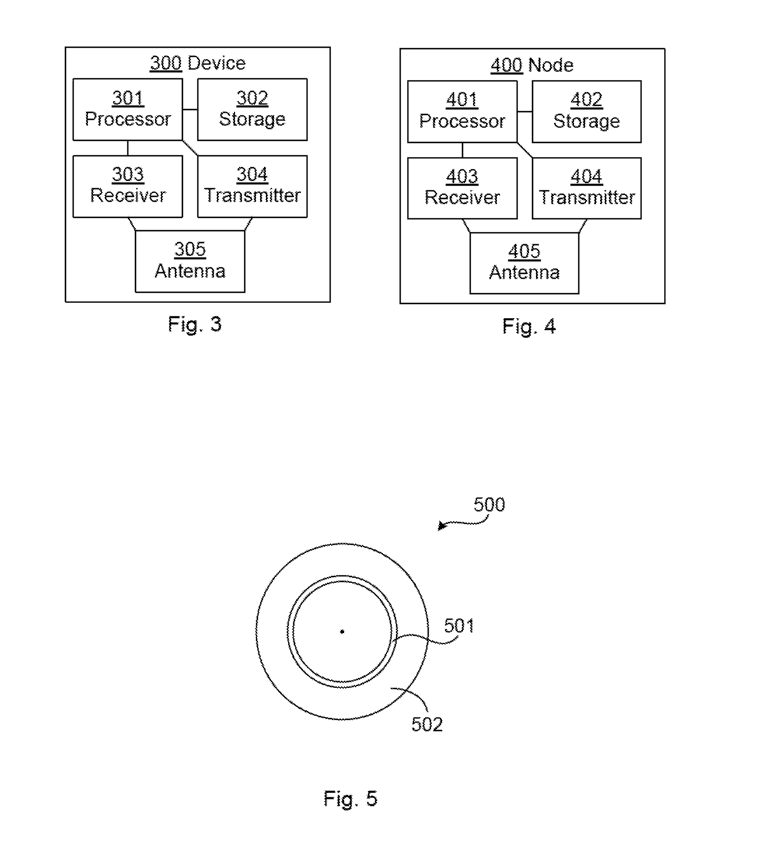

FIG. 3 schematically illustrates an embodiment of a radio device 300 of the present disclosure. The radio device 300 may be any device, mobile or stationary, enabled to communicate over the radio cannel in the communications network, e.g. M2M communication or MTC communication, for instance but not limited to e.g. user equipment (UE), mobile phone, smart phone, modem, sensors, meters, vehicles, household appliances, medical appliances, media players, cameras, or any type of consumer electronic, for instance but not limited to television, radio, lighting arrangements, tablet computer, laptop, or PC, or any (other) MTC radio devices. In the present disclosure, the radio device is exemplified with an MTC device, since MTC devices may be prone to behave in such a way (many devices accessing the cellular network at the same time, in response to an event) in which the embodiments of present disclosure may be beneficial. The device 300 comprises a processor/processor circuitry 301, e.g. in the form of a central processing unit (CPU). The processor 301 may comprise one or a plurality of processing units in the form of microprocessor(s). However, other suitable devices with computing capabilities could be used, e.g. an application specific integrated circuit (ASIC), a field programmable gate array (FPGA) or a complex programmable logic device (CPLD). The processor 301 is configured to run one or several computer program(s) or software stored in a storage unit 302, e.g. in the form of a memory. The storage unit 302 is regarded as a computer readable means and may e.g. be in the form of a Random Access Memory (RAM), a Flash memory or other solid state memory, or a hard disk. The processor 301 is also configured to store data in the storage unit 302, as needed. The device 300 also comprises a transmitter 304, a receiver 303 and an antenna 305, which may be combined to form a transceiver or be present as distinct units within the device 300. The transmitter 304 is configured to cooperate with the processor 301 to transform data bits to be transmitted over a radio interface to a suitable radio signal in accordance with the Radio Access Technology (RAT) used by the Radio Access network (RAN) via which the data bits are to be transmitted. The receiver 303 is configured to cooperate with the processor 301 to transform a received radio signal to transmitted data bits. The antenna 305 may comprise a single antenna or a plurality of antennas, e.g. for different frequencies and/or for MIMO (Multiple Input Multiple Output) communication. The antenna 305 is used by the transmitter 304 and the receiver 303 for transmitting and receiving, respectively, radio signals.

FIG. 4 schematically illustrates an embodiment of a network node 400 of the present disclosure. The node 400 may be any network node involved with communication with a radio device over a control channel, such as any Radio Base Station (RBS), e.g. an eNB of an LTE communication standard. The network node 400 comprises a processor/processor circuitry 401 e.g. a central processing unit (CPU). The processor 401 may comprise one or a plurality of processing units in the form of microprocessor(s). However, other suitable devices with computing capabilities could be comprised in the processor 401, e.g. an application specific integrated circuit (ASIC), a field programmable gate array (FPGA) or a complex programmable logic device (CPLD). The processor 401 is configured to run one or several computer program(s) or software stored in a storage unit 402 e.g. a memory. The storage unit is regarded as a computer readable means and may e.g. be in the form of a Random Access Memory (RAM), a Flash memory or other solid state memory, or a hard disk. The processor 401 is also configured to store data in the storage unit 402, as needed. The network node 400 also comprises a transmitter 404, a receiver 403 and an antenna 405, which may be combined to form a transceiver or be present as distinct units within the network node 400. The transmitter 404 is configured to cooperate with the processor 401 to transform data bits to be transmitted over a radio interface to a suitable radio signal in accordance with the radio access technology (RAT) used by the Radio Access Network (RAN) via which the data bits are to be transmitted. The receiver 403 is configured to cooperate with the processor 401 to transform a received radio signal to transmitted data bits. The antenna 405 may comprise a single antenna or a plurality of antennas, e.g. for different frequencies and/or for MIMO (Multiple Input Multiple Output) communication. The antenna 405 is used by the transmitter 404 and the receiver 403 for transmitting and receiving, respectively, radio signals. The network node 400 may also comprise a communication interface (not shown) for communication with other nodes of the communication network, e.g. in the Core Network (CN).

FIG. 5 illustrates a computer program product 500. The computer program product 500 comprises a computer readable medium 502 comprising a computer program 501 in the form of computer-executable components 501. The computer program/computer-executable components 501 may be configured to cause e.g. a radio device 300 or a network node 400, e.g. as discussed above, to perform an embodiment of a method of the present disclosure. The computer program/computer-executable components may be run on the processing unit 301 of the radio device 300 or on the processing unit 401 of the network node 400 for causing the device to perform the method. The computer program product 500 may e.g. be comprised in the storage unit 302 comprised in the radio device 300 or in the storage unit 402 in the network node 400 and associated with the processing unit 301 or 401, respectively. Alternatively, the computer program product 500 may be, or be part of, a separate, e.g. mobile, storage means, such as a computer readable disc, e.g. CD or DVD or hard disc/drive, or a solid state storage medium, e.g. a RAM or Flash memory.

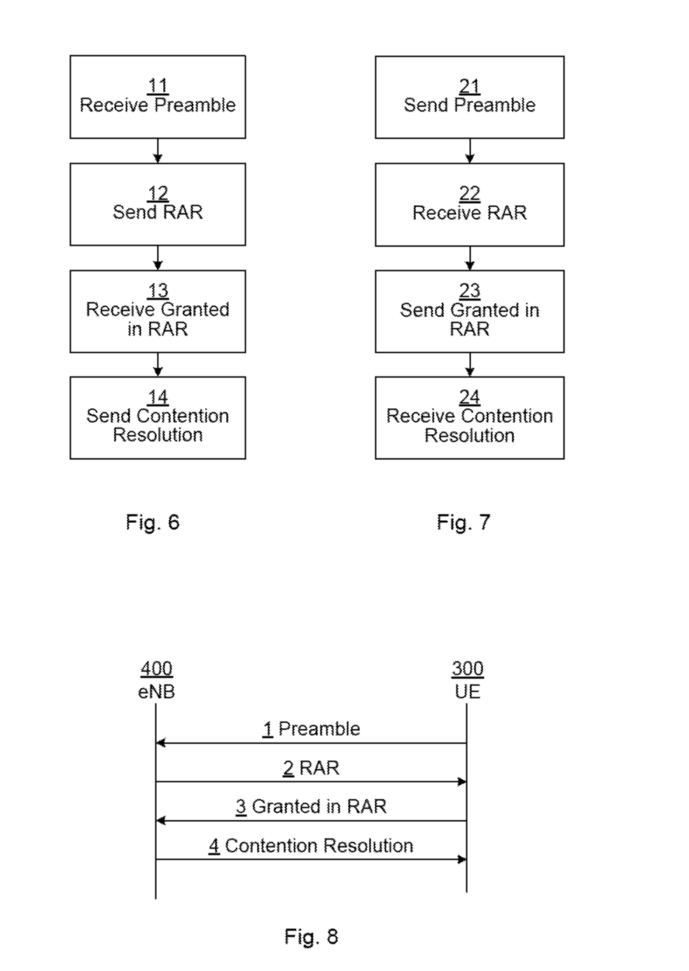

FIG. 6 is a flow chart illustrating an embodiment of a method of a network node 400, according the present disclosure. Respective preamble transmissions 1 are received 11 from at least two radio devices 300. A RAR transmission 2 is sent 12 to the at least two radio devices. Respective granted in RAR transmissions 3 are received 13 from the at least two radio devices. A contention resolution transmission 4 is sent 14 on a physical downlink control channel (PDCCH) to the at least two radio devices 300, using a shared identifier such that the same, shared, identifier is used for identifying all of said at least two radio devices.

FIG. 7 is a flow chart illustrating an embodiment of a method of a radio device 300, according the present disclosure. A preamble transmission 1 is sent 21 to a network node 400. A RAR transmission 2 is received 22 from said network node, said RAR transmission comprising information about a shared identifier which will be used for a contention resolution transmission 4. A granted in RAR transmissions 3 is sent 23 to the network node. The contention resolution transmission 4 is received 24 on a physical downlink control channel (PDCCH), which identifies the radio device 300 by a shared identifier which is also identifying at least one other radio device concurrently connecting to the network node 400.

FIG. 8 is a schematic signalling diagram illustrating a contention based LTE RACH procedure according to the present disclosure. The figure illustrates how the four messages 1-4 are transmitted between a network node 400 in the form of an eNB and a radio device 300 in the form of a UE. A preamble message 1 is transmitted from the UE 300 to the eNB 400. Then, a RAR message 2 is transmitted from the eNB 400 to the UE 300. In response to the RAR message 2, a granted in RAR message 3 is transmitted from the UE 300 to the eNB 400. Then, a contention resolution message 4 is transmitted from the eNB 400 to the UE 300.

In the following, embodiments of the present disclosure are discussed by means of a few illustrative examples, in which it is assumed that two MTC devices are accessing the cellular network at the same time.

### Example 1

In this example, the Random Access RNTI (RA-RNTI) is continued to be used also for the contention resolution transmission 4.

Two MTC devices 300 have data to send and thus wait for the next Random Access Channel (RACH) occasion in order to try to access the network. In case access is not barred, the devices then send 21 (different) randomly chosen RACH preambles 1 during the RACH occasion. The network (typically via network node 400) detects 11 two preambles, and responds 12 with the Random Access Response (RAR) 2 including these two preambles. In the legacy case, the network would in this step assign different temporary cell RNTIs (C-RNTIs) to the two radio devices 300. This is still done, however, both the devices are also informed by the network node 400 that the use of the RA-RNTI will continue for the downlink transmission 14 of the contention resolution transmission 4, for example by means of a bit in the RAR transmission 2.

Since RA-RNTI is calculated based on the RACH occasion timing, it should be possible to continue the use of it, at least for a short while, e.g., before the next time instant when the same RA-RNTI will result from the calculation again. When the contention resolution transmission 4 is addressed to two or more radio devices 300 with a common PDCCH allocation, i.e. RA-RNTI, then a way to separate data for the different devices in the DL allocation of the data channel may be needed.

A way to separate data for different devices 300 in the payload is with the help of Media Access Control (MAC) control elements (CEs) or MAC sub-headers indicating which data belongs to which device. The separation in MAC could be done with

1. (Temporary) C-RNTI

2. A separate new ID related to the common allocation only. A separate ID could be signalled explicitly in the Random Access Response message 2 for each selected random access preamble, or the ID could be implicitly derived based on the preamble location in the RAR.

3. Other identifier, e.g. a contention resolution identity, which comprises a System Architecture Evolution (SAE) Temporary Mobile Subscriber Identity (S-TMSI).

The procedure above is in conformity with the signalling depicted in FIG. 2 discussed above.

### Example 2

As an alternative to the continued usage of RA-RNTI in Example 1, a new shared RNTI may be used for the contention resolution transmission 4.

Two MTC radio devices 300 have data to send and thus wait for the next Random Access Channel (RACH) occasion in order to try to access the network. In case access is not barred, the devices then send 21 (different) randomly chosen RACH preambles 1 during the RACH occasion. The network (typically via network node 400) detects 11 the two preambles, and responds 12 with the Random Access Response (RAR) 2. In the legacy case, the network would in this step assign different temporary C-RNTIs to the two devices 300. However, now both devices 300 are assigned with the same temporary C-RNTI that they will from now on share. Sharing of temporary C-RNTI can be visible to the devices 300 or not (i.e. the devices may or may not be aware that they share the C-RNTI). Furthermore, the network may additionally assign separate private C-RNTIs to the devices, if there is a need at some point to address a single device 300 for some reason. This may be done in the same RAR message 2 with a new field, or later on in the process.

Transmission 14 of the contention resolution message 4 will be done as in Example 1, i.e., by using in-band separation of data.

After the contention resolution message 4 sending 14 is complete, the network may stop using the shared RNTI and start addressing the radio devices primarily with the private RNTIs. The network may additionally or alternatively continue to use the shared RNTI for DL transmissions just as for the contention resolution message 4 whenever it sees fit. If both private and shared C-RNTIs are used in parallel, the device 300 may need to try to decode both C-RNTIs on some subframes.

### Example 3

The new shared RNTI may also be used for most communication, in addition to the contention resolution message 4.

It is possible to complement the use of a shared RNTI of Example 2 for DL transmissions in two additional ways:

(1) Also UL transmissions are shared by granting resources to the shared RNTI using the principles and grant formats of the contention based UL described in the 3GPP Technical Report (TR) 37.868, the part related to RAN overload control, and/or in WO 2011/086525 (international application number PCT/IB 2011/050177) “Methods and apparatus for contention-based granting in a wireless communication network” to TELEFONAKTIEBOLAGET LM ERICSSON (PUBL).

(2) Alternatively, or additionally, the C-RNTI sharing principles outlined in WO 2012/044211 (international application number PCT/SE2010/051036) “A method and an arrangement for sharing of a first cell radio network temporary identifier” to TELEFONAKTIEBOLAGET LM ERICSSON (publ) are used to share the C-RNTI between the radio devices 300.

The C-RNTI sharing of (2), above, can additionally or alternatively be in accordance with a method in a radio communication system for assigning a short-lived C-RNTI to a first radio device 300 performing random access to a radio network node 400. The radio communication system registers the first radio device 300 as connected to the radio network node 400. In this manner, the short-lived C-RNTI is assigned to the first radio device 300 for identification thereof during a first time period. Next, a message for synchronizing the radio network node 400 and the first radio device 300 with respect to the first time period is transferred from the radio network node to the first radio device 300. After the first time period has elapsed, the first radio device 300 is maintained connected to the radio network node 400. Furthermore, the radio communication system allows the short-lived C-RNTI to be assigned to a second radio device 300. Thereby, the radio communication system enables use of the short-lived C-RNTI for identification of the second radio device when the second radio device is connected to the radio network node 400.

Similarly, the C-RNTI sharing of (2), above, can additionally or alternatively be in accordance with a first radio device 300 for enabling assignment of a short-lived C-RNTI to the first radio device performing random access to a radio network node 400. The first radio device comprises a processing circuit 301 adapted to register the first radio device as connected to the radio network node. The short-lived C-RNTI is assignable to the first radio device 300 for identification thereof during a first time period. Furthermore, the processing circuit 301 further is adapted to maintain the first radio device connected to the radio network node 400 after the first time period has elapsed, and to refrain from considering the short-lived C-RNTI as assigned to the radio device after the first time period has elapsed, thereby enabling use of the short-lived C-RNTI for identification of the second radio device 300 when connected to the radio network node. The first radio device also comprises a receiver 303 adapted to receive, from the radio network node 400, a message for synchronizing the radio network node and the first radio device with respect to the first time period.

Similarly, the C-RNTI sharing of (2), above, can additionally or alternatively be in accordance with a radio network node 400 for assigning a short-lived C-RNTI to a first radio device 300 performing random access to the radio network node. The radio network node comprises a processing circuit 401 adapted to register the first radio device as connected to the radio network node. The short-lived C-RNTI is assignable to the first radio device for identification thereof during a first time period. Furthermore, the processing circuit 401 further is adapted to maintain the first radio device connected to the radio network node after the first time period has elapsed, and to allow the short-lived C-RNTI to be assigned to a second radio device after the first time period has elapsed, thereby enabling use of the short-lived C-RNTI for identification of the second radio device when connected to the radio network node. The radio network node 400 also comprises a transmitter 404 adapted to send, to the first radio device, a message for synchronizing the radio network node and the first radio device 300 with respect to the first time period.

Since the first radio device is maintained connected to the radio network node after the first time period has elapsed and that the second radio device is allowed to be connected to the radio network node after the first time period has elapsed, the first radio device may remain connected to the radio network node without restricting the second radio device possibility to connect to the radio network node. In this manner, the short-lived C-RNTI is allowed to be reused after the first time period has elapsed, typically the first time period is short, such as a few seconds, tens of seconds, a couple of minutes or the like. The first time period may be indicative time elapsed since last dedicated transmission (in either direction) between the first radio device and the radio network node. Thanks to that the short-lived C-RNTI is allowed to be reused, the second radio device may become connected to the radio network node by performing random access and may be assigned the short-lived C-RNTI for identification the second radio device. As a result, large amounts of communication devices, such as radio devices 300 or MTC devices 300, are connectable to a radio network node 400.

Advantageously, in scenarios where the number of available C-RNTIs is small, radio devices 300 will not be disallowed to connect to the radio network node due to that there is no available C-RNTI. Instead, an available short-lived C-RNTI will be assigned to the radio device for a short period, given by the first time period.

### Example 4

The same data can be transmitted from the network node 400 to a plurality of radio devices 300.

In many cases, a DL message addressed to the shared C-RNTI includes the same data for different radio devices. For example, the contention resolution message 4 can at least partly be common for different devices 300 since the RRC Connection Setup command in the message carries RRC control parameters that are typically the same. In another scenario, a DL message might be used for handling a group of the devices 300, in which case the data is, also, the same.

If the radio devices are allocated with the shared RNTI, it is possible to broadcast common data for many devices. Each DL message, i.e. MAC Protocol Data Unit (PDU), can include a common data part and a device specific data part. These device specific parts can be separated in the payload similarly to what is suggested in the preceding examples, i.e. the common part is identified by the shared RNTI and the device specific part is identified by the device specific identifier.

Below follow some other aspects of the present disclosure.

According to an aspect of the present disclosure, there is provided a radio network node 400. The node comprises means (e.g. the processor 401 and/or the receiver 403) for receiving respective preamble transmissions 1 from at least two radio devices 300. The node 400 also comprises means (e.g. the processor 401 and/or the transmitter 404) for sending a RAR transmission 2 to the at least two radio devices 300. The node 400 also comprises means (e.g. the processor 401 and/or the receiver 403) for receiving respective granted in RAR transmissions 3 from the at least two radio devices 300. The node 400 also comprises means (e.g. the processor 401 and/or the transmitter 404) for sending a contention resolution transmission 4 on a PDCCH to the at least two radio devices 300, using a shared identifier such that the same, shared, identifier is used for identifying all of said at least two radio devices.

According to another aspect of the present disclosure, there is provided a radio network node 400. The node 400 comprises receiver circuitry 403 for receiving respective preamble transmissions 1 from at least two radio devices 300. The node 400 also comprises transmitter circuitry 404 for sending a RAR transmission 2 to the at least two radio devices 300. The node 400 also comprises receiver circuitry 403 for receiving respective granted in RAR transmissions 3 from the at least two radio devices 300. The node 400 also comprises transmitter circuitry 404 for sending a contention resolution transmission 4 on a PDCCH to the at least two radio devices 300, using a shared identifier such that the same, shared, identifier is used for identifying all of said at least two radio devices.

Any of the radio network node aspects of the present disclosure may be used for performing an embodiment of the radio network node method of the present disclosure.

According to another aspect of the present disclosure, there is provided a radio device 300. The radio device 300 comprises means (e.g. the processor 301 and/or the transmitter 304) for sending a preamble transmission 1 to a network node 400. The radio device 300 comprises means (e.g. the processor 301 and/or the receiver 303) for receiving a RAR transmission 2 from said network node 400, said RAR transmission comprising information about a shared identifier which will be used for a contention resolution transmission 4. The radio device 300 also comprises means (e.g. the processor 301 and/or the transmitter 304) for sending a granted in RAR transmission 3 to the network node 400. The radio device 300 comprises means (e.g. the processor 301 and/or the receiver 303) for receiving the contention resolution transmission 4 on a PDCCH, which identifies the radio device 300 by a shared identifier which is also identifying at least one other radio device 300 concurrently connecting to the network node.

According to another aspect of the present disclosure, there is provided a radio device 300. The radio device 300 comprises transmitter circuitry 304 for sending a preamble transmission 1 to a network node 400. The radio device 300 also comprises receiver circuitry 303 for receiving a RAR transmission 2 from said network node 400, said RAR transmission comprising information about a shared identifier which will be used for a contention resolution transmission 4. The radio device 300 also comprises transmitter circuitry 304 for sending the granted in RAR transmission 3 to the network node 400. The radio device 300 also comprises receiver circuitry 303 for receiving the contention resolution transmission 4 on a PDCCH, which identifies the radio device 300 by a shared identifier which is also identifying at least one other radio device 300 concurrently connecting to the network node 400.

Any of the radio device aspects of the present disclosure may be used for performing an embodiment of the radio device method of the present disclosure.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method performed by a radio network node, the method comprising:
receiving respective Preamble transmissions from at least two radio devices;
sending a Random Access Response (RAR) transmission to the at least two radio devices;
receiving respective Granted in RAR transmissions from the at least two radio devices; and
sending a Contention Resolution transmission on a physical downlink control channel, PDCCH, to the at least two radio devices, using a shared identifier such that the same, shared, identifier is used for identifying all of said at least two radio devices.

2. The method of claim 1, wherein the shared identifier is a shared Radio Network Temporary Identifier, RNTI.

3. The method of claim 1, wherein the shared identifier is a shared Random Access RNTI, RA-RNTI.

4. The method of claim 1, wherein the shared identifier is a shared Cell RNTI, C-RNTI.

5. The method of claim 1, wherein the RAR transmission comprises information to the at least two radio devices about which identifier will be used for the Contention Resolution transmission.

6. The method of claim 5, wherein said information also comprises information that the identifier will be an identifier shared between a plurality of radio devices.

7. The method of claim 5, wherein said information comprises information about private identifiers for each of the at least two radio devices.

8. (canceled)

9. A radio network node (400), the node comprising:
a processor; and
a storage unit storing instructions that, when executed by the processor, cause the node to:
receive respective Preamble transmissions from at least two radio devices;
send a RAR transmission to the at least two radio devices;
receive respective Granted in RAR transmissions from the at least two radio devices; and
send a Contention Resolution transmission on a physical downlink control channel, PDCCH, to the at least two radio devices, using a shared identifier such that the same, shared, identifier is used for identifying all of said at least two radio devices.

10. A computer readable medium on which is stored computer program code which is configured to, when run on a processor of a network node, cause the network node to:
receive respective Preamble transmissions from at least two radio devices;
send a RAR transmission to the at least two radio devices;
receive respective Granted in RAR transmissions from the at least two radio devices; and
send a Contention Resolution transmission on a physical downlink control channel, PDCCH, to the at least two radio devices, using a shared identifier such that the same, shared, identifier is used for identifying all of said at least two radio devices.

11. (canceled)

12. A method performed by a radio device, the method comprising:
sending a Preamble transmission to a network node;
receiving a RAR transmission from said network node, said RAR transmission comprising information about a shared identifier which will be used for a Contention Resolution transmission;
sending a Granted in RAR transmissions to the network node; and
receiving the Contention Resolution transmission on a physical downlink control channel, PDCCH, which identifies the radio device by a shared identifier which is also identifying at least one other radio device concurrently connecting to the network node.

13. The method of claim 12, wherein the information comprised in the RAR transmission also comprises information about a private identifier for the radio device.

14. (canceled)

15. A radio device, the radio device comprising:
a processor; and
a storage unit storing instructions that, when executed by the processor (301), cause the radio device to:
send a Preamble transmission to a network node;
receive a RAR transmission from said network node, said RAR transmission comprising information about a shared identifier which will be used for a Contention Resolution transmission;
send a Granted in RAR transmissions to the network node; and
receive the Contention Resolution transmission on a physical downlink control channel, PDCCH, which identifies the radio device by a shared identifier which is also identifying at least one other radio device concurrently connecting to the network node.

16. A computer readable medium on which is stored computer program code which is configured to, when run on a processor of a radio device, cause the radio device to:
send a Preamble transmission to a network node;
receive a RAR transmission from said network node, said RAR transmission comprising information about a shared identifier which will be used for a Contention Resolution transmission;
send a Granted in RAR transmissions (3) to the network node; and
receive the Contention Resolution transmission on a physical downlink control channel, PDCCH, which identifies the radio device by a shared identifier which is also identifying at least one other radio device concurrently connecting to the network node.

17. (canceled)
